(19) United States
(12) Patent Application Publication
(10) Pub. No.: US 2006/0273567 A1
(43) Pub. Date: Dec. 7, 2006

(54) Locking module for locking a steering column and a corresponding steering column

(76) Inventor: Vincent Fix, Strasbourg (FR)

Correspondence Address: WENDEROTH, LIND & PONACK, L.L.P., 2033 K STREET N. W., SUITE 800, WASHINGTON, DC, 20006-1021, US

(21) Appl. No.: 11/442,988

(22) Filed: May 31, 2006

(30) Foreign Application Priority Data
Jun. 2, 2005 (FR) 05 05601

(51) Int. Cl. B62D 1/18

(52) U.S. Cl. 280/775

(57) ABSTRACT

The locking module for locking a steering column, the locking module being of the type comprising two locking flanges mounted to move relative to each other between a locking configuration for locking the steering column and a releasing configuration for releasing the steering column. The locking module further comprises cam-forming means. The two flanges are mounted to move relative to each other along a control movement path. The locking module further comprises a locking device distinct from the cam-forming means and adapted to lock the two locking flanges in their locking configuration. Application to motor vehicle steering columns.

The present invention relates to a locking module for locking a steering column, the locking module being of the type comprising two locking flanges mounted to move relative to each other between a locking configuration for locking the steering column and a releasing configuration for releasing the steering column, the two flanges being mounted to move relative to each other along a control movement path, the locking module further comprising cam-forming means adapted to move the two locking flanges mutually along a locking movement path when said locking flanges are moved along the control movement path.

### BACKGROUND OF THE INVENTION

From the state of the art, e.g. from Patent Application US-2003/0221505, it is known that a locking module for locking a steering column exists that comprises two locking flanges which are mounted to move in rotation about a central axis between a locking configuration and a releasing configuration. In the locking configuration, the two locking supports are spaced apart along the axis and hold a steering column in its adjusted position. In their releasing configuration, the two locking flanges are brought together along the axis and make it possible to adjust the position of the steering column.

In the locking configuration, an actuating lever that makes it possible to move the two locking flanges between their two configurations, is held by friction force only.

Therefore, the force necessary to move the control lever between the locking position and the releasing position is not defined, which can give rise to untimely displacement of the two locking flanges towards their releasing configuration and to undesired displacement of the steering column if the user does not apply the locking lever sufficiently tightly. In any event, the clamping force acting on the two locking flanges is not defined in the context of that known module. Therefore, that locking module lacks safety.

In addition, when a large clamping force for clamping the column is desired, the force necessary for overcoming the friction force of the control lever becomes too large, which is detrimental to the ergonomics of the device.

Another device that is known, for example from Document U.S. Pat. No. 5,921,577, has a locking cam on which a rolling element rolls between the locking position and the releasing position. The cam has an intermediate peak, so that the rolling element is locked in its locking position. That device thus suffers from high wear on the cam at the intermediate peak. In addition, the intermediate peak results in the cams having movement strokes that are long, and thus in the device being voluminous.

### OBJECTS AND SUMMARY OF THE INVENTION

An object of the invention is to increase the safety of the known locking module, by using means that are simple and inexpensive.

To this end, the invention provides a locking module of the type indicated above that further comprises a locking device distinct from the cam-forming means and adapted to lock the two locking flanges in their locking configuration.

In particular embodiments, the locking module has one or more of the following characteristics:
it has a first locking member and a second locking member that are complementary with each other and that co-operate with each other at least in a locking configuration by means of their complementary shapes;
the locking device is adapted to generate a resistance force to be overcome that locally opposes movement of the two locking flanges from their locking configuration to their releasing configuration;
the first locking device is a locking finger fastened to one of the locking flanges, and the second locking member is provided with a projection fastened to the other of the locking flanges;
the second locking member is carried by an insert fastened to the locking flange;
the locking module further comprises holding means adapted to hold at least the two locking flanges so that the module can be handled independently as a single unit;
the holding means comprise at least one holding lug disposed on the insert and adapted to hold the locking flanges relative to each other independently;
the module further comprises a damper device adapted to damp the movement of the two locking flanges as they move towards their releasing configuration;
the damper device includes a damper member that is the locking finger;
the damper device includes a ramp that is formed by a slot that narrows going towards the locking position in which the locking finger is locked;
the cam-forming means co-operate with rolling elements; and
the cam-forming means are adapted to move the two locking flanges in a single locking direction extending along the locking movement path when the locking flanges are moved in a control direction from their locking configuration into their releasing configuration.

The invention also provides an assembly including a holding support and a steering column, provided with a steering shaft, said assembly is provided with a module as defined above, one of the locking flanges being fastened to the holding support in the locking configuration and the other locking flange being fastened to the steering column.

### BRIEF DESCRIPTION OF THE DRAWINGS

The invention can be better understood on reading the following description given merely by way of example and with reference to the accompanying drawings, in which:

FIG. 1 is a perspective view of a locking assembly of the invention for locking a steering column, shown in the locked state;

FIG. 2 is a view of the assembly of FIG. 1, in the released state;

FIG. 3 is an exploded view of the locking module of the invention;

FIG. 4 is a detail view in section of a cam of the locking module of the invention; and

FIG. 5 is an enlarged plan view of a locking member of the locking module of the invention.

### MORE DETAILED DESCRIPTION

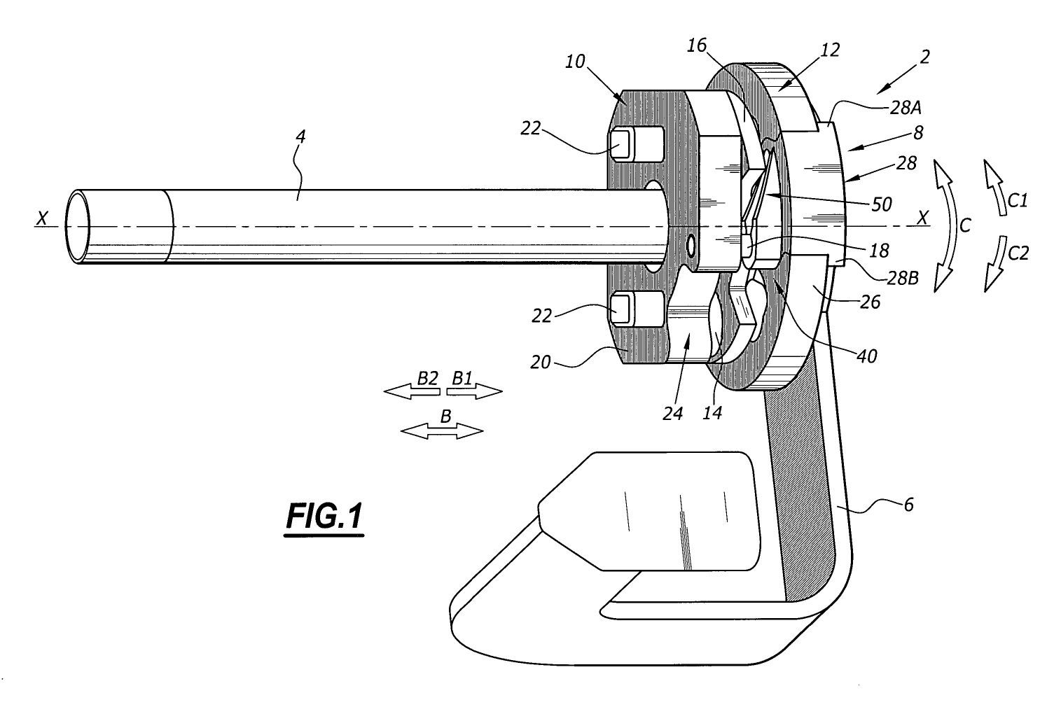

FIG. 1 shows a locking assembly of the invention, designated by the overall reference 2, for locking a steering column.

The assembly 2 comprises a threaded tie rod 4 extending around a central axis X-X, a control lever 6, and a locking module 8.

The locking module 8 is provided with a first locking flange 10, with a second locking flange 12, with three rolling bearing bodies, in the form of balls 14, and a cage 16 interposed between the first and second flanges 10, 12. The locking module 8 is further provided with a locking finger 18 fastened to the locking flange 10.

The first locking flange 10 is constituted by a polygonal plate 20 made of metal, extending perpendicularly to the axis X-X, and provided with two axial projections 22 via which the first locking flange 10 can engage releasably into a holding support (not shown) for holding the steering column. In addition, the plate 20 is provided with a setback 24.

In a variant, the plate 20 is not polygonal in shape, but rather it is of some other shape that is determined by the space available inside the vehicle. Similarly, the plate 26 is not necessarily circular in shape, but rather it can be of different shape.

The locking flange 12 comprises a metal plate 26 that is substantially circular and that extends perpendicularly to the axis X-X. The control lever 6 is fastened to said plate 26. The locking flange 12 is further provided with an insert 28 which is fastened to the circular plate 26, preferably by means of complementary shapes. A slot 29 is provided in said insert 28.

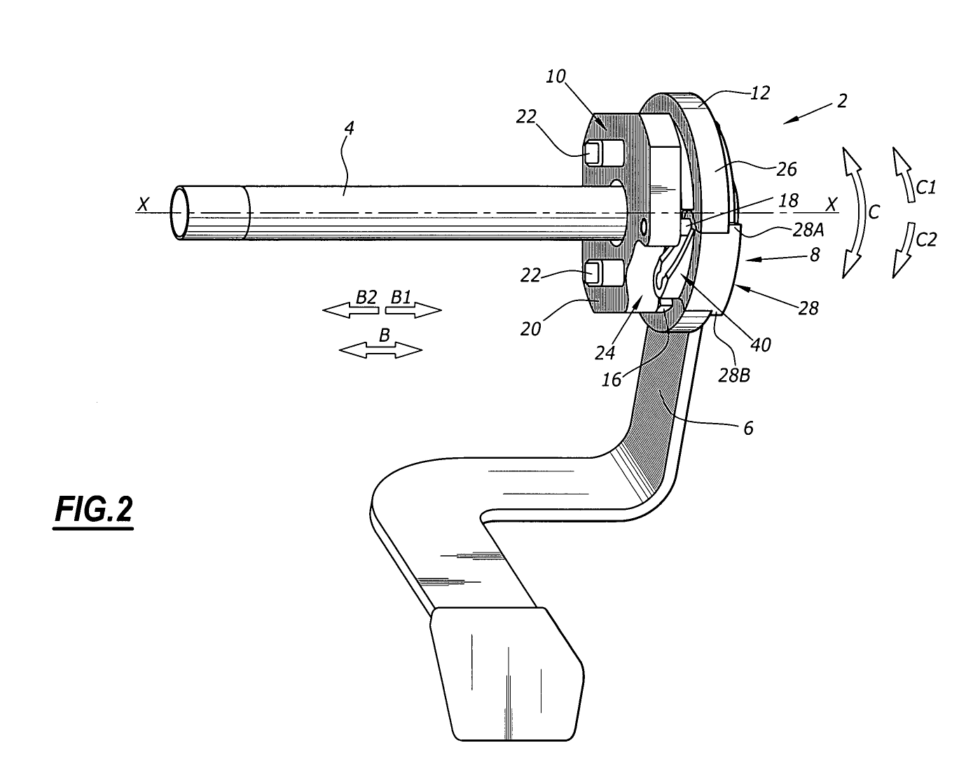

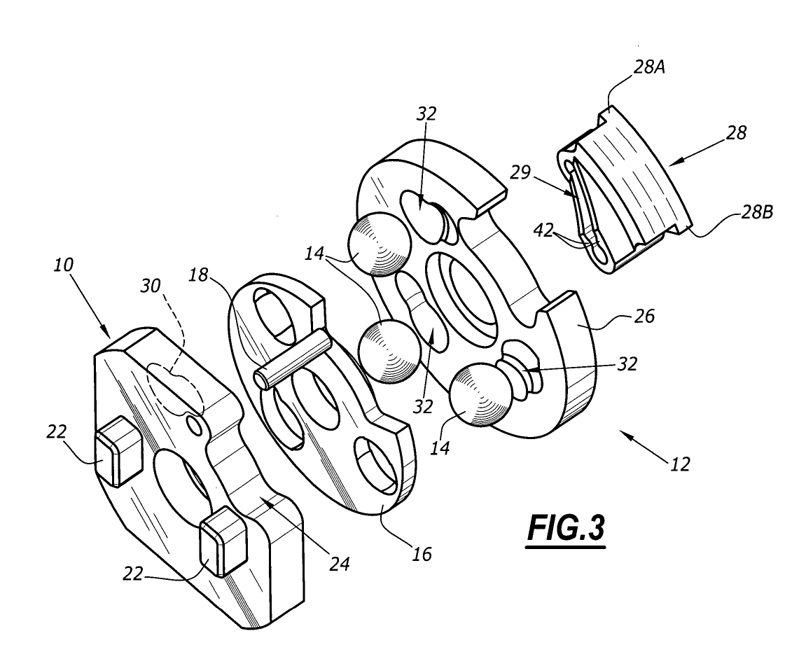

As shown in FIG. 3, the locking module 8 is further provided with three displacement cams 30 provided in the first locking flange 10, and with three displacement cams 32 provided in the second locking flange 12. The balls 14 are adapted to roll on said displacement cams 30, 32. The first locking flange 10 and the second locking flange 12 are moveable relative to each other between a locking configuration, shown in FIG. 1 and a releasing configuration, shown in FIG. 2. In the locking configuration, the steering column is held stationary relative to the holding support, whereas, in the releasing configuration, the steering column is moveable relative to said holding support, and its position can be adjusted.

To this end, the two locking flanges 10, 12 are mounted to move relative to each other along a control movement path C, which, in this example, is a path for movement in rotation about the axis X-X. The control movement path C is made up of a first control direction C1 and of a second control direction C2 opposite from the first direction C1. The cams 30, 32 are adapted to move the two locking flanges 10, 12 in mutual translation along a locking movement path B when the two locking flanges 10, 12 are moved along the control movement path C. In this example, the locking movement path B extends along the axis X-X. The locking movement path B is made up of a first locking direction B1 and of a second locking direction B2. The locking direction B1 tends to move the second locking flange 12 away from the first locking flange 10, when said second locking flange 12 is moved in the direction C1.

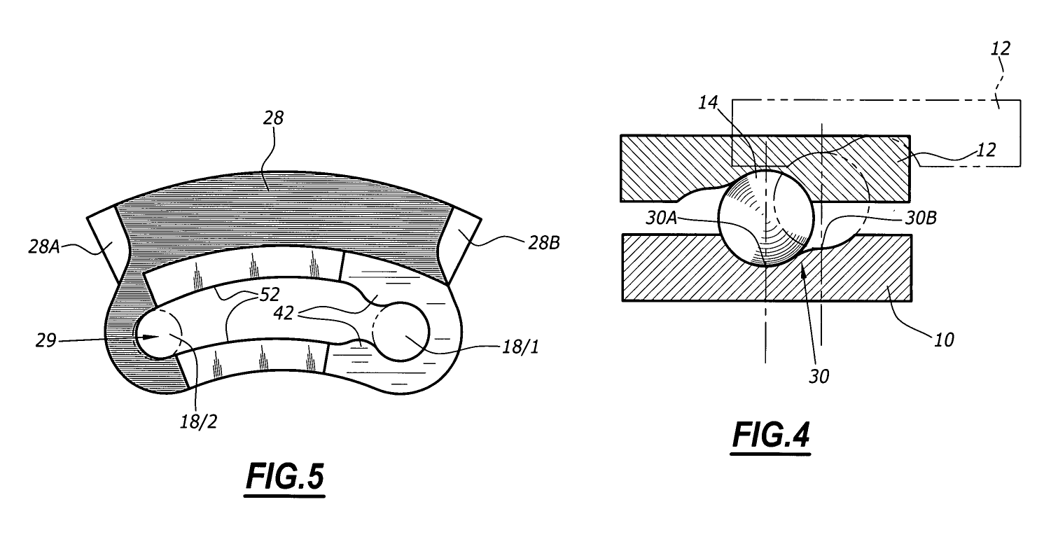

FIG. 4 shows the cam 30 in more detail. The cam 30 has a set-back portion 30A which corresponds to the releasing configuration, and a raised portion 30B which corresponds to the locking configuration. As shown in FIG. 4, the cam 30 extends between the set-back portion 30A and the raised portion 30B exclusively by rising towards the raised portion 30B. Therefore, the cams 30, 32 move the two locking flanges 10, 12 in the locking direction B1 only, along the locking movement path B, when the locking flanges 10, 12 are moved from their locking configuration to their releasing configuration. Thus, the locking module 8 has a locking stroke along the movement path B that is long for a given displacement of the lever 6 around the axis X-X.

The locking module 8 is further provided with a locking device 40 adapted to lock the two locking flanges 10, 12 in their locking configuration. The locking device 40 has a first locking member fastened to the first locking flange 10, which member is, in this example, formed by the locking finger 18, and a second locking member fastened to the second locking flange 12 and formed, in this example, by two projections 42 extending radially into the stroke of the locking finger 18. The locking finger 18 and the projections 42 co-operating opposes movement of the second locking support 12 from its locking position towards its releasing position. The projections 42 are thus adapted to generate a resistance force to be overcome that locally opposes movement of the two locking flanges 10, 12. In order to facilitate understanding, the position of the locking finger 18 in the locking configuration is indicated at 18/1 in FIG. 5.

In a variant, the second locking member is formed by one projection 42 only, instead of by two projections.

The locking module 8 is further provided with a damper device 50 adapted to damp the movement of the locking flanges 10, 12 as they move towards their releasing configuration. The damper device 50 is provided with two facing ramps 52 formed by the slot 29.

The slot 29 narrows going towards that position of the locking finger 18 which corresponds to the releasing configuration, thereby damping the movement of the two locking flanges 10, 12 as they move towards their releasing configuration. The position of the locking finger 18 that corresponds to the releasing configuration is indicated at 18/2 in FIG. 5.

It can be understood that the slot 29 and the locking finger 18 also form two abutments, each of which defines one of the configurations, namely the locking configuration or the releasing configuration.

In addition, the insert 28 is provided with two holding lugs 28A, 28B which come to bear axially against the locking flange 12. When the locking finger 18 is in its position 18/2 corresponding to the releasing configuration, it is held axially by friction in the slot 29. By means of this friction force and by means of the holding lugs 28A, 28B, the locking module constituted by the first locking flange 10, by the second locking flange 12, by the three rolling bearing bodies 14, by the cage 16, by the locking finger 18, and by the insert 28 is held independently in an assembled state and can be handled as a single unit.

By means of the finger 18 and by means of the projections 42, the force for moving the two locking flanges 10, 12 into or out of the locking configuration is predetermined.

In addition, by means of the fact that the locking device 40 and the damper device 50 are constituted by the same elements, namely by the locking finger 18 and by the insert 28, facilitates manufacturing the module 8.

The fact that the displacement cams 30, 32 are dissociated operationally from the locking device 40 makes it possible to provide a large displacement for the two locking flanges 10, 12 for a given angle of rotation. The absence of peaks in the cams contributes to obtaining this technical effect.

The rolling bearings 14 can be replaced with other rolling elements, e.g. by cylindrical rollers or by conical rollers.

In another variant, the locking finger 18 is fastened on the second locking flange 12 while the insert 28 is fastened to the first locking flange 10.

What is claimed is:

1. A locking module for locking a steering column, the locking module being of the type comprising two locking flanges mounted to move relative to each other between a locking configuration for locking the steering column and a releasing configuration for releasing the steering column, the two flanges being mounted to move relative to each other along a control movement path, the locking module further comprising cam-forming means adapted to move the two locking flanges mutually along a locking movement path when said locking flanges are moved along the control movement path, wherein the locking module further comprises a locking device distinct from the cam-forming means and adapted to lock the two locking flanges in their locking configuration.

2. A locking module according to claim 1, wherein the locking device comprises a first locking member and a second locking member that are complementary with each other and that co-operate with each other at least in a locking configuration by means of complementary shapes.

3. A locking module according to claim 2, wherein the locking device is adapted to generate a resistance force to be overcome that locally opposes movement of the two locking flanges from their locking configuration to their releasing configuration.

4. A locking module according to claim 2, wherein the first locking member is a locking finger fastened to one of the locking flanges, and wherein the second locking member is provided with a projection fastened to the other of the locking flanges.

5. A locking module according to claim 2, wherein the second locking member is carried by an insert fastened to the locking flange.

6. A locking module according to claim 4, further comprising holding means adapted to hold at least the two locking flanges so that the module can be handled independently as a single unit.

7. A locking module according to claim 6, wherein the second locking member is carried by an insert fastened to the locking flange, and wherein the holding means comprise at least one holding lug disposed on the insert and adapted to hold the locking flanges relative to each other independently.

8. A locking module according to claim 1, wherein the module further comprises a damper device adapted to damp the movement of the two locking flanges as they move towards their releasing configuration.

9. A locking module according to claim 4, wherein the module further comprises a damper device adapted to damp the movement of the two locking flanges as they move towards their releasing configuration, and wherein the damper device includes a damper member that is the locking finger.

10. A locking module according to claim 9, wherein the damper device includes a ramp that is formed by a slot that narrows going towards the locking position in which the locking finger is locked.

11. A locking module according to claim 1, wherein the cam-forming means co-operate with rolling elements.

12. A locking module according to claim 1, wherein the cam-forming means are adapted to move the two locking flanges in a single locking direction extending along the locking movement path when the locking flanges are moved in a control direction from their locking configuration into their releasing configuration.

13. An assembly including a holding support and a steering column, provided with a steering shaft, said assembly is provided with a module according to claim 1, one of the locking flanges being fastened to the holding support in the locking configuration and the other locking flange being fastened to the steering column.
